(19) United States
(12) Patent Application Publication
(10) Pub. No.: US 2016/0379561 A1
(43) Pub. Date: Dec. 29, 2016

(54) CONTROL CIRCUIT AND CONTROL METHOD OF AMOLED PARTITION DRIVE

(71) Applicant: Shenzhen China Star Optoelectronics Technology Co. Ltd., Shenzhen City (CN)

(72) Inventors: Yufeng Jin, Shenzhen City (CN); Shensian Syu, Shenzhen City (CN); Mingjong Jou, Shenzhen City (CN)

(21) Appl. No.: 14/771,498

(22) PCT Filed: Jun. 25, 2015
(86) PCT No.: PCT/CN2015/082259

§ 371 Date: Aug. 30, 2015

(51) Int. Cl. G09G 3/3233

(52) U.S. Cl. CPC G09G 3/3233; G09G 2330/02; G09G 2320/0626; G09G 2320/066

(57) ABSTRACT

The present invention provides a control circuit and a control method of AMOLED partition drive. The AMOLED display panel (100) is divided into a plurality of display partitions, and a plurality of first leads (PIN1) and second leads (PIN2) of which amounts are equal to an amount of the plurality of display partitions, and the pixel driving circuit (101) in each display partition is coupled to the power source positive electrode line (OVDD) via one first lead (PIN1), and coupled to the power source negative electrode line (OVSS) via one second lead (PIN2), and a plurality of external switches, positioned outside the AMOLED display panel (100), of which an amount is equal to the amount of the display partitions, and each external switch is correspondingly coupled to one first lead (PIN1) and the power source positive electrode line (OVDD), or each external switch is correspondingly coupled to one second lead (PIN2) and the power source negative electrode line (OVSS), and the external sequence controller (TCON) provides the control signal to each external switch. It can ensure the display effect when the AMOLED shows black or a darker image to eliminate the stress between the cathode and the anode of the organic light emitting diode.

### FIELD OF THE INVENTION

The present invention relates to a display technology field, and more particularly to a control circuit and a control method of AMOLED partition drive.

### BACKGROUND OF THE INVENTION

The Organic Light Emitting Display (OLED) possesses many outstanding properties of self-illumination, low driving voltage, high luminescence efficiency, short response time, high clarity and contrast, near 180° view angle, wide range of working temperature, applicability of flexible display and large scale full color display. The OLED is considered as the most potential display device.

The OLED can be categorized into two major types according to the driving methods, which are the Passive Matrix OLED (PMOLED) and the Active Matrix OLED (AMOLED), i.e. two types of the direct addressing and the Thin Film Transistor (TFT) matrix addressing. The AMOLED comprises pixels arranged in array and belongs to active display type, which has high lighting efficiency and is generally utilized for the large scale display devices of high resolution.

With the rising of the AMOLED TV, the demands of the people to the AMOLED TV functions have gradually increase. The AMOLED is a current driving element. When the electrical current flows through the organic light emitting diode, the organic light emitting diode emits light, and the brightness is determined according to the current flowing through the organic light emitting diode itself. Therefore, it is significantly important to the driving of the AMOLED and relates to the display effect and the lifetime of the AMOLED.

As shown in FIG. 1, the traditional AMOLED pixel driving circuit generally is 2T1C, which is a structure comprising two thin film transistors and one capacitor. Specifically, the traditional AMOLED pixel driving circuit comprises a first thin film transistor T1, a second thin film transistor T2 and a capacitor C1. The first thin film transistor T1 is a switching thin film transistor, and the second thin film transistor T2 is a driving thin film transistor, and the capacitor C1 is a storage capacitor. A gate of the first thin film transistor T1 is electrically coupled to a scan signal Scan, and a source is electrically coupled to a data signal Data, and a drain is electrically coupled to a gate of the second thin film transistor T2 and one end of the capacitor C1; a drain of the second thin film transistor T2 is directly coupled to a power source positive electrode line OVDD, and a source is electrically coupled to an anode of an organic light emitting diode D; a cathode of the organic light emitting diode D is electrically coupled to a power source negative electrode line OVSS; the one end of the capacitor C1 is electrically coupled to the drain of the first thin film transistor T1 and the gate of the second thin film transistor T2, and the other end is electrically coupled to the drain of the second thin film transistor T2. As the AMOLED displays, the scan signal Scan controls the first thin film transistor T1 to be activated, and the data signal Data enters the gate of the second thin film transistor T2 and the capacitor C1 via the first thin film transistor T1. Then, the first thin film transistor T1 is deactivated. With the storage function of the capacitor C1, the gate voltage of the second thin film transistor T2 still remains the data signal voltage to keep the second thin film transistor T2 to be in an on state, and the drive current enters the organic light emitting diode D via the second thin film transistor T2 to drive the organic light emitting diode D to illuminate. The second thin film transistor T2 is in charge of control the trans-voltage and the current of the organic light emitting diode D.

As the aforesaid traditional 2T1C pixel driving circuit of the AMOLED shows a dark image, the light of the OLED is similar to black, but the second thin film transistor T2 has the leakage current and is difficult to be controlled because the manufacture process of the TFT manufactured on the AMOLED display panel has defect and is unstable. The stress effect always exists between the cathode and the anode of the organic light emitting diode D, which makes the display effect of the AMOLED change and influence the lifetime of the AMOLED.

### SUMMARY OF THE INVENTION

An objective of the present invention is to provide a control circuit of AMOLED partition drive, capable of ensuring the display effect and eliminating the stress between the cathode and the anode of the organic light emitting diode when the AMOLED shows black or a darker image. The lifetime of the AMOLED can be extended without raising the manufacture difficulty of the AMOLED.

Another objective of the present invention is to provide a control method of AMOLED partition drive, capable of ensuring the display effect and eliminating the stress between the cathode and the anode of the organic light emitting diode when the AMOLED shows black or a darker image. The lifetime of the AMOLED can be extended.

For realizing the aforesaid objectives, the present invention provides a control circuit of AMOLED partition drive, comprising:

an AMOLED display panel, and the AMOLED display panel is divided into a plurality of display partitions arranged in array, and each display partition comprises a plurality of sub pixels, and each sub pixel comprises a pixel driving circuit;

a power source positioned outside the AMOLED display panel, a power source positive electrode line coupled to a power source positive electrode, and a power source negative electrode line coupled to a power source negative electrode;

a plurality of first leads and second leads of which amounts are equal to an amount of the plurality of display partitions, and the pixel driving circuit in each display partition is coupled to the power source positive electrode line via one first lead, and coupled to the power source negative electrode line via one second lead;

a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line;

an external sequence controller, and the external sequence controller provides a control signal to each external switch to control on or off of each external switch for controlling on or off of the pixel driving circuit in each display partition and the power source.

The external switch is a NMOS transistor or a PMOS transistor, and a gate of the NMOS transistor or the PMOS transistor receives the control signal provided by the external sequence controller, and a source is coupled to the power source positive electrode line, and a drain is coupled to the first lead.

The external switch is a NMOS transistor or a PMOS transistor, and a gate of the NMOS transistor or the PMOS transistor receives the control signal provided by the external sequence controller, and a source is coupled to the power source negative electrode line, and a drain is coupled to the second lead.

The external sequence controller provides the control signal to each external switch matching with a Local Dimming algorithm or a pulse-width modulation algorithm.

The pixel driving circuit comprises a first thin film transistor, a second thin film transistor and a capacitor; a gate of the first thin film transistor is electrically coupled to a scan signal, and a source is electrically coupled to a data signal, and a drain is electrically coupled to a gate of the second thin film transistor and one end of the capacitor; a drain of the second thin film transistor is coupled to the first lead, and a source is electrically coupled to an anode of an organic light emitting diode; a cathode of the organic light emitting diode is coupled to the second lead; the one end of the capacitor is electrically coupled to the drain of the first thin film transistor and the gate of the second thin film transistor, and the other end is electrically coupled to the drain of the second thin film transistor.

The present invention further provides a control circuit of AMOLED partition drive, comprising:

an AMOLED display panel, and the AMOLED display panel is divided into a plurality of display partitions arranged in array, and each display partition comprises a plurality of sub pixels, and each sub pixel comprises a pixel driving circuit;

a power source positioned outside the AMOLED display panel, a power source positive electrode line coupled to a power source positive electrode, and a power source negative electrode line coupled to a power source negative electrode;

a plurality of first leads and second leads of which amounts are equal to an amount of the plurality of display partitions, and the pixel driving circuit in each display partition is coupled to the power source positive electrode line via one first lead, and coupled to the power source negative electrode line via one second lead;

a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line;

an external sequence controller, and the external sequence controller provides a control signal to each external switch to control on or off of each external switch for controlling on or off of the pixel driving circuit in each display partition and the power source;

wherein the external switch is a NMOS transistor or a PMOS transistor, and a gate of the NMOS transistor or the PMOS transistor receives the control signal provided by the external sequence controller, and a source is coupled to the power source positive electrode line, and a drain is coupled to the first lead;

wherein the external sequence controller provides the control signal to each external switch matching with a Local Dimming algorithm or a pulse-width modulation algorithm;

wherein the pixel driving circuit comprises a first thin film transistor, a second thin film transistor and a capacitor; a gate of the first thin film transistor is electrically coupled to a scan signal, and a source is electrically coupled to a data signal, and a drain is electrically coupled to a gate of the second thin film transistor and one end of the capacitor; a drain of the second thin film transistor is coupled to the first lead, and a source is electrically coupled to an anode of an organic light emitting diode; a cathode of the organic light emitting diode is coupled to the second lead; the one end of the capacitor is electrically coupled to the drain of the first thin film transistor and the gate of the second thin film transistor, and the other end is electrically coupled to the drain of the second thin film transistor.

The present invention further provides a control method of AMOLED partition drive, comprising steps of:

step 1, providing a control circuit of AMOLED partition drive;

the control circuit of AMOLED partition drive comprises:

an AMOLED display panel, and the AMOLED display panel is divided into a plurality of display partitions arranged in array, and each display partition comprises a plurality of sub pixels, and each sub pixel comprises a pixel driving circuit;

a power source positioned outside the AMOLED display panel, a power source positive electrode line coupled to a power source positive electrode, and a power source negative electrode line coupled to a power source negative electrode;

a plurality of first leads and second leads of which amounts are equal to an amount of the plurality of display partitions, and the pixel driving circuit in each display partition is coupled to the power source positive electrode line via one first lead, and coupled to the power source negative electrode line via one second lead;

a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line;

and an external sequence controller;

step 2, the respective display partitions of the AMOLED display panel perform display, and the external sequence controller provides the control signal to each external switch according to a brightness condition of an image shown by each display partition, and controls the external switch corresponded with the display partition where a darker or black image is to be off for making the pixel driving circuit in the display partition where the darker or black display image is and the power source to be off.

In the step 2, the external sequence controller provides the control signal to each external switch matching with a Local Dimming algorithm or a pulse-width modulation algorithm.

The external switch is a NMOS transistor or a PMOS transistor, and a gate of the NMOS transistor or the PMOS transistor receives the control signal provided by the external sequence controller, and a source is coupled to the power source positive electrode line, and a drain is coupled to the first lead.

The external switch is a NMOS transistor or a PMOS transistor, and a gate of the NMOS transistor or the PMOS transistor receives the control signal provided by the external sequence controller, and a source is coupled to the power source negative electrode line, and a drain is coupled to the second lead.

The pixel driving circuit comprises a first thin film transistor, a second thin film transistor and a capacitor; a gate of the first thin film transistor is electrically coupled to a scan signal, and a source is electrically coupled to a data signal, and a drain is electrically coupled to a gate of the second thin film transistor and one end of the capacitor; a drain of the second thin film transistor is coupled to the first lead, and a source is electrically coupled to an anode of an organic light emitting diode; a cathode of the organic light emitting diode is coupled to the second lead; the one end of the capacitor is electrically coupled to the drain of the first thin film transistor and the gate of the second thin film transistor, and the other end is electrically coupled to the drain of the second thin film transistor.

The benefits of the present invention are: the present invention provides a control circuit and a control method of AMOLED partition drive. The AMOLED display panel is divided into a plurality of display partitions, and a plurality of first leads and second leads of which amounts are equal to an amount of the plurality of display partitions, and the pixel driving circuit in each display partition is coupled to the power source positive electrode line via one first lead, and coupled to the power source negative electrode line via one second lead, and a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line, and the external sequence controller provides the control signal to each external switch to control the external switch corresponded with the display partition where the darker or black display image is to be off for making the pixel driving circuit in the display partition where the darker or black display image is and the power source to be off. It can ensure the display effect and eliminate the stress between the cathode and the anode of the organic light emitting diode. The lifetime of the AMOLED can be extended without raising the manufacture difficulty of the AMOLED.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a circuit diagram of an AMOLED pixel driving circuit according to prior art;

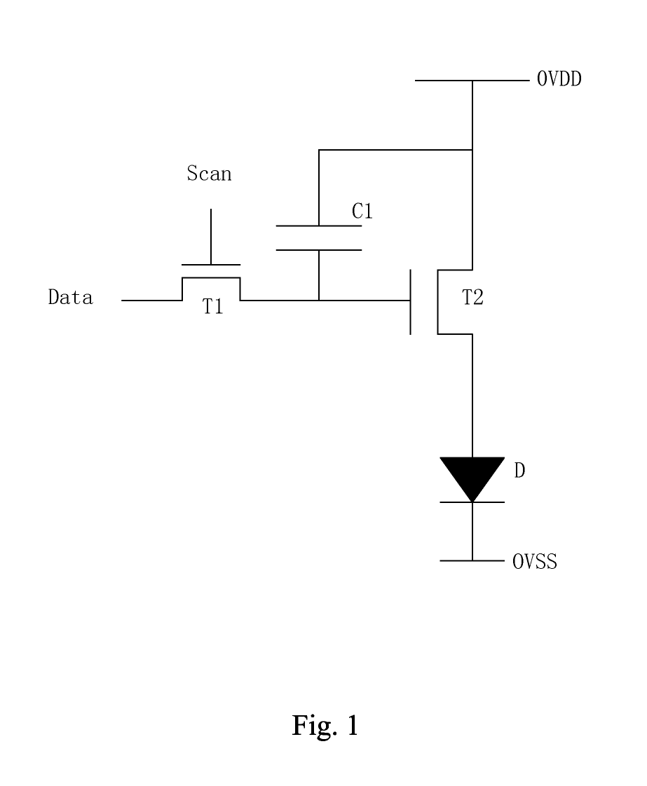

FIG. 2 is a circuit diagram of a control circuit of AMOLED partition drive according to the present invention;

FIG. 3 is a circuit diagram of an AMOLED pixel driving circuit in the control circuit of AMOLED partition drive according to the present invention;

FIG. 4 is a flowchart of a control method of AMOLED partition drive according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

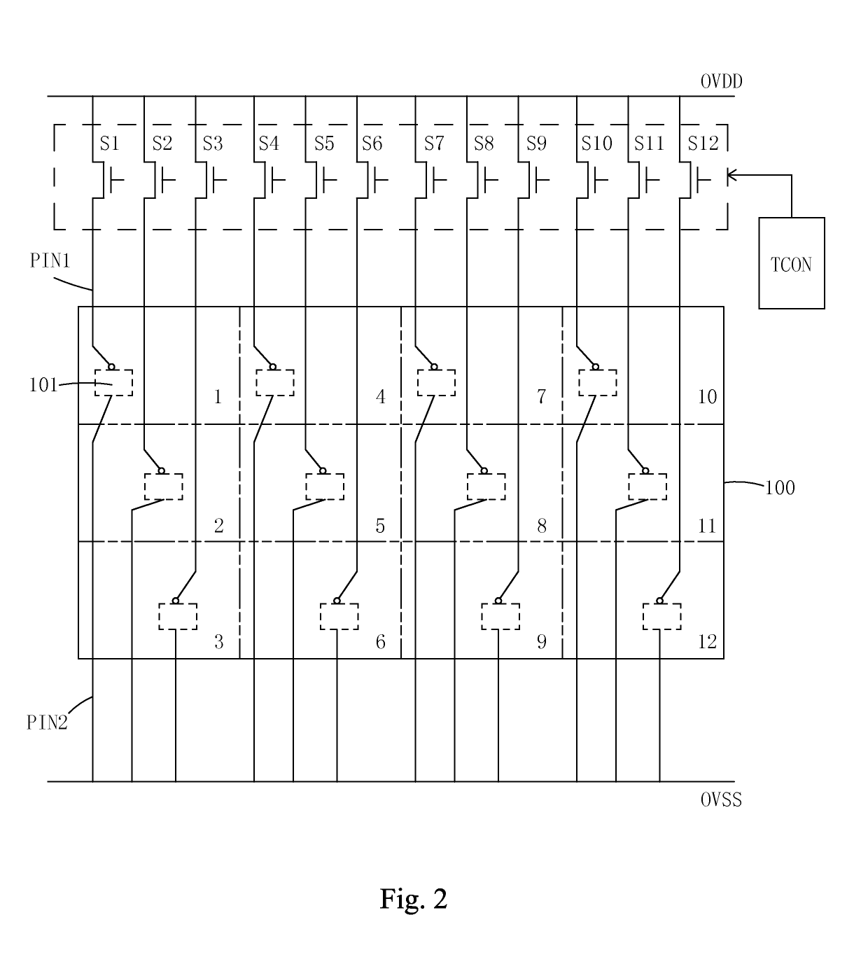

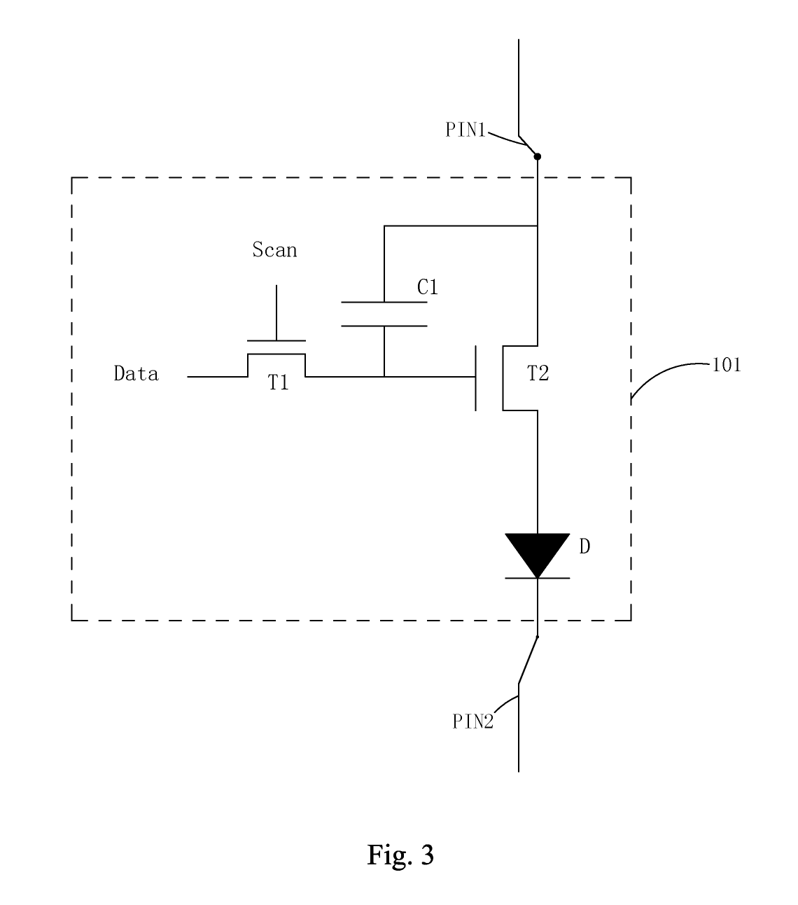

Please refer to FIG. 2 and FIG. 3. The present invention first provides a control circuit of AMOLED partition drive, comprising:

an AMOLED display panel 100, and the AMOLED display panel 100 is divided into a plurality of display partitions arranged in array, and each display partition comprises a plurality of sub pixels, and each sub pixel comprises a pixel driving circuit 101; the amount of display partitions for dividing the AMOLED display panel 100 is not restricted and can be determined according to the practical demands. As shown in FIG. 2, the AMOLED display panel 100 is divided into 12 display partitions, which respectively are a display partition 1, a display partition 2, and until a display partition 12;

a power source (not shown) positioned outside the AMOLED display panel 100, a power source positive electrode line OVDD coupled to a power source positive electrode, and a power source negative electrode line OVSS coupled to a power source negative electrode;

a plurality of first leads PIN1 and second leads PIN2 of which amounts are equal to an amount of the plurality of display partitions, and the pixel driving circuit 101 in each display partition is coupled to the power source positive electrode line OVDD via one first lead PIN1, and coupled to the power source negative electrode line OVSS via one second lead PIN2; as shown in FIG. 2, 12 first leads PIN1 and 12 second leads PIN2 are provided.

a plurality of external switches, positioned outside the AMOLED display panel 100, of which an amount is equal to the amount of the display partitions, and as shown in FIG. 2, 12 external switches S1, S2, and until S12, and each external switch is correspondingly coupled to one first lead PIN1 and the power source positive electrode line OVDD, such as the external switch S1 is coupled to one first lead PIN1 corresponding to the display partition 1 and the power source positive electrode line OVDD, and the external switch S12 is coupled to one first lead PIN1 corresponding to the display partition 12 and the power source positive electrode line OVDD; FIG. 2 shows that the plurality of external switches are arranged at the side close to the power source positive electrode line OVDD, and certainly, the plurality of external switches are arranged at the side close to the power source negative electrode line OVSS, and each external switch is correspondingly coupled to one second lead PIN2 and the power source negative electrode line OVSS;

an external sequence controller TCON, and the external sequence controller TCON provides a control signal to each external switch to control on or off of each external switch for controlling on or off of the pixel driving circuit 101 in each display partition and the power source.

Specifically, the external switch can be a NMOS transistor which is on as being controlled with a high voltage level signal, and off as being controlled with a low voltage level signal; the external switch also can be a PMOS transistor which is on as being controlled with the low voltage level signal, and off as being controlled with the high voltage level signal. Furthermore, as shown in FIG. 2, a gate of the NMOS transistor or the PMOS transistor receives the control signal provided by the external sequence controller TCON, and a source is coupled to the power source positive electrode line OVDD, and a drain is coupled to the first lead PIN1; alternatively, a gate of the NMOS transistor or the PMOS transistor receives the control signal provided by the external sequence controller TCON, and a source is coupled to the power source negative electrode line OVSS, and a drain is coupled to the second lead PIN2. Different from the manufacture of the TFT inside the AMOLED display panel with the array manufacture process, the manufacture process of the NMOS transistor or PMOS transistor is implemented outside the AMOLED display panel. The restriction to the manufacture process is less, and the manufacture difficulty is lower and the yield is higher. Therefore, using the NMOS transistor or PMOS transistor to be the external switch, the great switch result can be easily achieved.

As shown in FIG. 3, the pixel driving circuit 101 comprises a first thin film transistor T1, a second thin film transistor T2 and a capacitor C1; a gate of the first thin film transistor T1 is electrically coupled to a scan signal Scan, and a source is electrically coupled to a data signal Data, and a drain is electrically coupled to a gate of the second thin film transistor T2 and one end of the capacitor C1; a drain of the second thin film transistor T2 is coupled to the first lead PIN1, and a source is electrically coupled to an anode of an organic light emitting diode D; a cathode of the organic light emitting diode D is coupled to the second lead PIN2; the one end of the capacitor C1 is electrically coupled to the drain of the first thin film transistor T1 and the gate of the second thin film transistor T2, and the other end is electrically coupled to the drain of the second thin film transistor T2.

When the respective display partitions of the AMOLED display panel 100 perform display, and the external sequence controller TCON provides the control signal to each external switch according to a brightness condition of an image shown by each display partition, and controls the external switch corresponded with the display partition where a darker or black display image is to be off for making the pixel driving circuit in the display partition where the darker or black display image is and the power source to be off to stop the leakage current. It can ensure the display effect and eliminate the stress between the cathode and the anode of the organic light emitting diode D. The lifetime of the AMOLED can be extended. Furthermore, the external sequence controller TCON provides the control signal to each external switch matching with a Local Dimming algorithm or a Pulse Width Modulation (PWM) algorithm for ensuring the no image distortion. The Local Dimming algorithm or the PWM algorithm has already applied in the liquid crystal display which belongs to prior art. No detail description is conducted here.

The display partition 1, where the darker or black display image is shown in FIG. 2 is illustrated. The external sequence controller TCON provides the control signal of low voltage level to the external switch S1, i.e. the NMOS transistor to off the NMOS transistor for making the pixel driving circuit 101 in the display partition 1 and the power source positive electrode line OVDD to be off, i.e. making the pixel driving circuit 101 in the display partition 1 and the power source to be off to stop the leakage current. The stress between the cathode and the anode of the organic light emitting diode D in the display partition 1 can be eliminated.

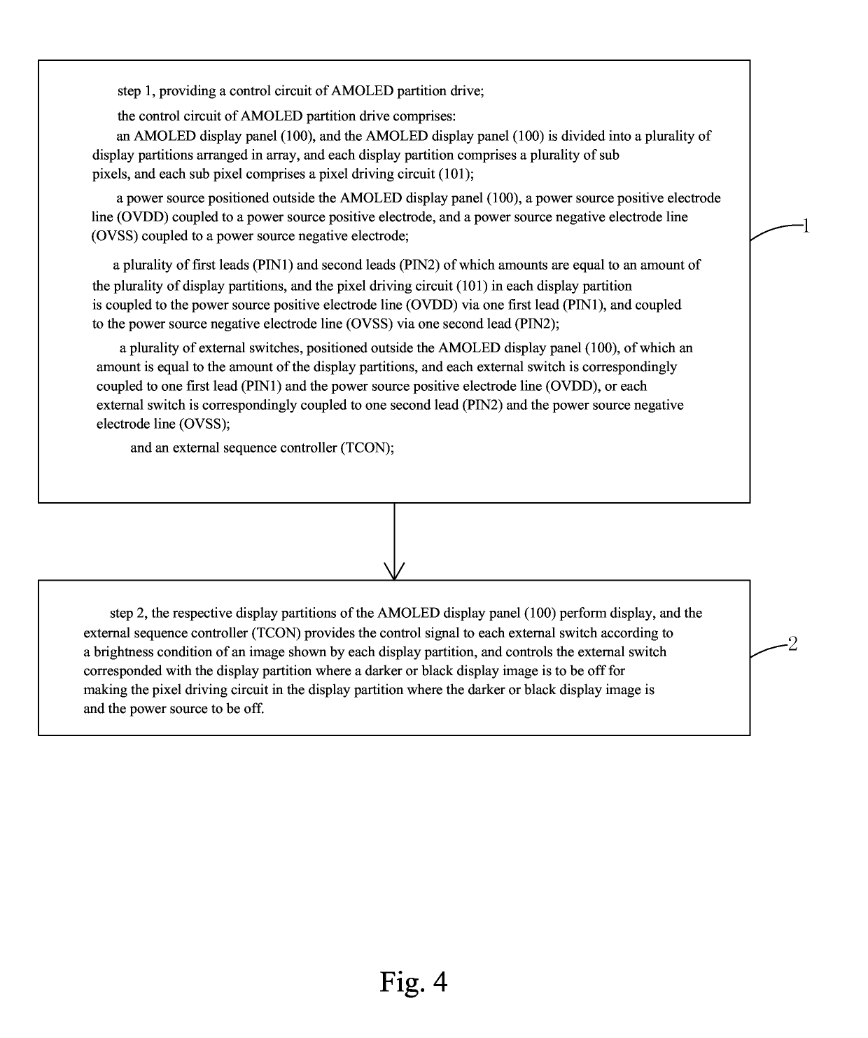

Please refer to FIG. 4 with combination of FIG. 2 and FIG. 3. The present invention further provides a control method of AMOLED partition drive, comprising steps of:

step 1, providing a control circuit of AMOLED partition drive.

As shown in FIG. 2, FIG. 3, the control circuit of AMOLED partition drive comprises:

an AMOLED display panel 100, and the AMOLED display panel 100 is divided into a plurality of display partitions arranged in array, and each display partition comprises a plurality of sub pixels, and each sub pixel comprises a pixel driving circuit 101; the amount of display partitions for dividing the AMOLED display panel 100 is not restricted and can be determined according to the practical demands. As shown in FIG. 2, the AMOLED display panel 100 is divided into 12 display partitions, which respectively are a display partition 1, a display partition 2, and until a display partition 12;

a power source (not shown) positioned outside the AMOLED display panel 100, a power source positive electrode line OVDD coupled to a power source positive electrode, and a power source negative electrode line OVSS coupled to a power source negative electrode;

a plurality of first leads PIN1 and second leads PIN2 of which amounts are equal to an amount of the plurality of display partitions, and the pixel driving circuit 101 in each display partition is coupled to the power source positive electrode line OVDD via one first lead PIN1, and coupled to the power source negative electrode line OVSS via one second lead PIN2; as shown in FIG. 2, 12 first leads PIN1 and 12 second leads PIN2 are provided.

a plurality of external switches, positioned outside the AMOLED display panel 100, of which an amount is equal to the amount of the display partitions, and as shown in FIG. 2, 12 external switches S1, S2, and until S12, and each external switch is correspondingly coupled to one first lead PIN1 and the power source positive electrode line OVDD, such as the external switch S1 is coupled to one first lead PIN1 corresponding to the display partition 1 and the power source positive electrode line OVDD, and the external switch S12 is coupled to one first lead PIN1 corresponding to the display partition 12 and the power source positive electrode line OVDD; FIG. 2 shows that the plurality of external switches are arranged at the side close to the power source positive electrode line OVDD, and certainly, the plurality of external switches are arranged at the side close to the power source negative electrode line OVSS, and each external switch is correspondingly coupled to one second lead PIN2 and the power source negative electrode line OVSS;

and an external sequence controller TCON.

Specifically, the external switch can be a NMOS transistor which is on as being controlled with a high voltage level signal, and off as being controlled with a low voltage level signal; the external switch also can be a PMOS transistor which is on as being controlled with the low voltage level signal, and off as being controlled with the high voltage level signal. Furthermore, as shown in FIG. 2, a gate of the NMOS transistor or the PMOS transistor receives the control signal provided by the external sequence controller TCON, and a source is coupled to the power source positive electrode line OVDD, and a drain is coupled to the first lead PIN1; alternatively, a gate of the NMOS transistor or the PMOS transistor receives the control signal provided by the external sequence controller TCON, and a source is coupled to the power source negative electrode line OVSS, and a drain is coupled to the second lead PIN2. Different from the manufacture of the TFT inside the AMOLED display panel with the array manufacture process, the manufacture process of the NMOS transistor or PMOS transistor is implemented outside the AMOLED display panel. The restriction to the manufacture process is less, and the manufacture difficulty is lower and the yield is higher. Therefore, using the NMOS transistor or PMOS transistor to be the external switch, the great switch result can be easily achieved.

As shown in FIG. 3, the pixel driving circuit 101 comprises a first thin film transistor T1, a second thin film transistor T2 and a capacitor C1; a gate of the first thin film transistor T1 is electrically coupled to a scan signal Scan, and a source is electrically coupled to a data signal Data, and a drain is electrically coupled to a gate of the second thin film transistor T2 and one end of the capacitor C1; a drain of the second thin film transistor T2 is coupled to the first lead PIN1, and a source is electrically coupled to an anode of an organic light emitting diode D; a cathode of the organic light emitting diode D is coupled to the second lead PIN2; the one end of the capacitor C1 is electrically coupled to the drain of the first thin film transistor T1 and the gate of the second thin film transistor T2, and the other end is electrically coupled to the drain of the second thin film transistor T2.

step 2, the respective display partitions of the AMOLED display panel 100 perform display, and the external sequence controller TCON provides the control signal to each external switch according to a brightness condition of an image shown by each display partition, and controls the external switch corresponded with the display partition where a darker or black display image is to be off for making the pixel driving circuit in the display partition where the darker or black display image is and the power source to be off.

The display partition 1, where the darker or black display image is shown in FIG. 2 is illustrated. The external sequence controller TCON provides the control signal of low voltage level to the external switch S1, i.e. the NMOS transistor to off the NMOS transistor for making the pixel driving circuit 101 in the display partition 1 and the power source positive electrode line OVDD to be off, i.e. making the pixel driving circuit 101 in the display partition 1 and the power source to be off to stop the leakage current. The stress between the cathode and the anode of the organic light emitting diode D in the display partition 1 can be eliminated.

Furthermore, the external sequence controller TCON provides the control signal to each external switch matching with a Local Dimming algorithm or a PWM algorithm for ensuring the no image distortion.

In the aforesaid control method of AMOLED partition drive, the external sequence controller TCON provides the control signal to control the external switch corresponded with the display partition where a darker or black display image to be off for making the pixel driving circuit in the display partition where the darker or black display image is and the power source to be off to stop the leakage current. It can ensure the display effect and eliminate the stress between the cathode and the anode of the organic light emitting diode D in the display partition. The lifetime of the AMOLED can be extended.

In conclusion, in the control circuit and the control method of AMOLED partition drive according to the present invention, the AMOLED display panel is divided into a plurality of display partitions, and a plurality of first leads and second leads of which amounts are equal to an amount of the plurality of display partitions, and the pixel driving circuit in each display partition is coupled to the power source positive electrode line via one first lead, and coupled to the power source negative electrode line via one second lead, and a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line, and the external sequence controller provides the control signal to each external switch to control the external switch corresponded with the display partition where the darker or black display image is to be off for making the pixel driving circuit in the display partition where the darker or black display image is and the power source to be off. It can ensure the display effect and eliminate the stress between the cathode and the anode of the organic light emitting diode. The lifetime of the AMOLED can be extended without raising the manufacture difficulty of the AMOLED.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A control circuit of AMOLED partition drive, comprising:
an AMOLED display panel, and the AMOLED display panel is divided into a plurality of display partitions arranged in array, and each display partition comprises a plurality of sub pixels, and each sub pixel comprises a pixel driving circuit;
a power source positioned outside the AMOLED display panel, a power source positive electrode line coupled to a power source positive electrode, and a power source negative electrode line coupled to a power source negative electrode;
a plurality of first leads and second leads of which amounts are equal to an amount of the plurality of display partitions, and the pixel driving circuit in each display partition is coupled to the power source positive electrode line via one first lead, and coupled to the power source negative electrode line via one second lead;
a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line;
an external sequence controller, and the external sequence controller provides a control signal to each external switch to control on or off of each external switch for controlling on or off of the pixel driving circuit in each display partition and the power source.

2. The control circuit of AMOLED partition drive according to claim 1, wherein the external switch is a NMOS transistor or a PMOS transistor, and a gate of the NMOS transistor or the PMOS transistor receives the control signal provided by the external sequence controller, and a source is coupled to the power source positive electrode line, and a drain is coupled to the first lead.

3. The control circuit of AMOLED partition drive according to claim 1, wherein the external switch is a NMOS transistor or a PMOS transistor, and a gate of the NMOS transistor or the PMOS transistor receives the control signal provided by the external sequence controller, and a source is coupled to the power source negative electrode line, and a drain is coupled to the second lead.

4. The control circuit of AMOLED partition drive according to claim 1, wherein the external sequence controller provides the control signal to each external switch matching with a Local Dimming algorithm or a pulse-width modulation algorithm.

5. The control circuit of AMOLED partition drive according to claim 1, wherein the pixel driving circuit comprises a first thin film transistor, a second thin film transistor and a capacitor; a gate of the first thin film transistor is electrically coupled to a scan signal, and a source is electrically coupled to a data signal, and a drain is electrically coupled to a gate of the second thin film transistor and one end of the capacitor; a drain of the second thin film transistor is coupled to the first lead, and a source is electrically coupled to an anode of an organic light emitting diode; a cathode of the organic light emitting diode is coupled to the second lead; the one end of the capacitor is electrically coupled to the drain of the first thin film transistor and the gate of the second thin film transistor, and the other end is electrically coupled to the drain of the second thin film transistor.

6. A control circuit of AMOLED partition drive, comprising:
an AMOLED display panel, and the AMOLED display panel is divided into a plurality of display partitions arranged in array, and each display partition comprises a plurality of sub pixels, and each sub pixel comprises a pixel driving circuit;
a power source positioned outside the AMOLED display panel, a power source positive electrode line coupled to a power source positive electrode, and a power source negative electrode line coupled to a power source negative electrode;
a plurality of first leads and second leads of which amounts are equal to an amount of the plurality of display partitions, and the pixel driving circuit in each display partition is coupled to the power source positive electrode line via one first lead, and coupled to the power source negative electrode line via one second lead;
a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line;
an external sequence controller, and the external sequence controller provides a control signal to each external switch to control on or off of each external switch for controlling on or off of the pixel driving circuit in each display partition and the power source;
wherein the external switch is a NMOS transistor or a PMOS transistor, and a gate of the NMOS transistor or the PMOS transistor receives the control signal provided by the external sequence controller, and a source is coupled to the power source positive electrode line, and a drain is coupled to the first lead;
wherein the external sequence controller provides the control signal to each external switch matching with a Local Dimming algorithm or a pulse-width modulation algorithm;
wherein the pixel driving circuit comprises a first thin film transistor, a second thin film transistor and a capacitor; a gate of the first thin film transistor is electrically coupled to a scan signal, and a source is electrically coupled to a data signal, and a drain is electrically coupled to a gate of the second thin film transistor and one end of the capacitor; a drain of the second thin film transistor is coupled to the first lead, and a source is electrically coupled to an anode of an organic light emitting diode; a cathode of the organic light emitting diode is coupled to the second lead; the one end of the capacitor is electrically coupled to the drain of the first thin film transistor and the gate of the second thin film transistor, and the other end is electrically coupled to the drain of the second thin film transistor.

7. A control method of AMOLED partition drive, comprising steps of:
step 1, providing a control circuit of AMOLED partition drive;
the control circuit of AMOLED partition drive comprises:
an AMOLED display panel, and the AMOLED display panel is divided into a plurality of display partitions arranged in array, and each display partition comprises a plurality of sub pixels, and each sub pixel comprises a pixel driving circuit;
a power source positioned outside the AMOLED display panel, a power source positive electrode line coupled to a power source positive electrode, and a power source negative electrode line coupled to a power source negative electrode;
a plurality of first leads and second leads of which amounts are equal to an amount of the plurality of display partitions, and the pixel driving circuit in each display partition is coupled to the power source positive electrode line via one first lead, and coupled to the power source negative electrode line via one second lead;
a plurality of external switches, positioned outside the AMOLED display panel, of which an amount is equal to the amount of the display partitions, and each external switch is correspondingly coupled to one first lead and the power source positive electrode line, or each external switch is correspondingly coupled to one second lead and the power source negative electrode line;
and an external sequence controller;
step 2, the respective display partitions of the AMOLED display panel perform display, and the external sequence controller provides the control signal to each external switch according to a brightness condition of an image shown by each display partition, and controls the external switch corresponded with the display partition where a darker or black image is to be off for making the pixel driving circuit in the display partition where the darker or black display image is and the power source to be off.

8. The control method of AMOLED partition drive according to claim 7, wherein in the step 2, the external sequence controller provides the control signal to each external switch matching with a Local Dimming algorithm or a pulse-width modulation algorithm.

9. The control method of AMOLED partition drive according to claim 7, wherein the external switch is a NMOS transistor or a PMOS transistor, and a gate of the NMOS transistor or the PMOS transistor receives the control signal provided by the external sequence controller, and a source is coupled to the power source positive electrode line, and a drain is coupled to the first lead.

10. The control method of AMOLED partition drive according to claim 7, wherein the external switch is a NMOS transistor or a PMOS transistor, and a gate of the NMOS transistor or the PMOS transistor receives the control signal provided by the external sequence controller, and a source is coupled to the power source negative electrode line, and a drain is coupled to the second lead.

11. The control method of AMOLED partition drive according to claim 7, wherein the pixel driving circuit comprises a first thin film transistor, a second thin film transistor and a capacitor; a gate of the first thin film transistor is electrically coupled to a scan signal, and a source is electrically coupled to a data signal, and a drain is electrically coupled to a gate of the second thin film transistor and one end of the capacitor; a drain of the second thin film transistor is coupled to the first lead, and a source is electrically coupled to an anode of an organic light emitting diode; a cathode of the organic light emitting diode is coupled to the second lead; the one end of the capacitor is electrically coupled to the drain of the first thin film transistor and the gate of the second thin film transistor, and the other end is electrically coupled to the drain of the second thin film transistor.
